(19) United States
(12) Patent Application Publication
(10) Pub. No.: US 2012/0265960 A1
(43) Pub. Date: Oct. 18, 2012

(54) ELECTRONIC DEVICE, ELECTRONIC TIMEPIECE, AND PROGRAM

(76) Inventor: Hisao Nakamura, Chiba-shi (JP)

(21) Appl. No.: 13/432,090

(22) Filed: Mar. 28, 2012

(30) Foreign Application Priority Data
Apr. 14, 2011 (JP) 2011-090425

(51) Int. Cl. G06F 12/02

(52) U.S. Cl. 711/171; 711/E12.002

(57) ABSTRACT

A CPU measures time. A memory unit stores the values of the times measured by the CPU as data groups for each measuring of time, and stores the data groups in association with protection information showing whether the data groups are in a protection state or an unprotected state. An input switch receives an instruction as an input. The CPU sets protection information stored in the memory unit on the basis of the instruction received by the input switch. Further, the CPU deletes the data of data groups in an unprotected state from the memory unit, on the basis of the protection information stored in the memory unit, when there is no capacity for storing the measured time values in the memory unit.

### BACKGROUND OF THE INVENTION

1. Field of the Invention

The present invention relate to an electronic device, an electronic timepiece, and a program.

2. Background Art

There are electronic timepieces with a stopwatch function that can store the value of time measured previously in a memory unit and display the measured time with a simple and easy operation without changing the operation mode even if the present time is displayed (for example, see JP-A-2002-22859). Further, there are stopwatches that do not store the value of time, which is measured after the capacity of a memory unit is full while measuring time in the memory unit or stopwatches that delete the oldest time value from a memory unit and then store a time value in the memory unit while measuring time.

However, in the stopwatches that do not store the value of time measured after the capacity of a memory unit becomes full and there is no available space in the memory unit, it is necessary to manually delete stored data in advance as the necessary space in order to store the measured time. Therefore, it is troublesome for the user to operate the stopwatch. Further, in stopwatches that delete the oldest time value from a memory unit and then store a time value in the memory unit when the capacity of the memory unit becomes full and there is no available space in the memory unit while measuring time, the oldest time value is automatically deleted even if the user wants to keep it.

### SUMMARY OF THE INVENTION

It is an aspect of the present application to provide an electronic device, an electronic timepiece, and a program which can store a newly measured time value, without deleting a measured time value that a user wants to remain, even if there is no available capacity in a memory unit.

An electronic device includes: a time measuring unit that measures time; a memory unit that stores the values of the times measured by the time measuring unit as data groups for each measuring of time, and stores the data groups in association with protection information showing whether the data groups are in a protection state or an unprotected state; an input unit that receives an input of an instruction; a protection information setting unit that sets the protection information stored in the memory unit on the basis of the instruction received by the input unit; and a deleting unit that deletes data of the data groups that are in the unprotected state from the memory unit, on the basis of the protection information stored in the memory unit, when there is no capacity for storing the values of the times measured by the time measuring unit in the memory unit.

The electronic device further includes a capacity memory unit that stores the data capacity that the memory unit can store and the total data capacity of the data groups in the unprotected state which are stored in the memory unit, or stores the total data capacity of the data group in the protection state which are stored in the memory unit and the total data capacity of the data groups in the unprotected state which are stored in the memory unit.

The deleting unit individually deletes the data groups stored in the memory unit or deletes all the data groups in the unprotected state in the data groups stored in the memory unit, on the basis of the instruction received by the input unit.

The electronic device further includes a feature determining unit that determines whether the value of the time measured by the time measuring unit is a feature value, in which the protection information setting unit, when the feature determining unit determines that the value of the time measured by the time measuring unit is the feature value, make the protection information associated with the data group including the value information showing a protection state.

The electronic device further includes a condition selection unit that selects a condition for the feature determining unit to determine whether the value is a feature value.

In the electronic device, a portion of or the entire memory unit is a nonvolatile memory.

An electronic timepiece includes: a time measuring unit that measures time; a memory unit that stores the values of the times measured by the time measuring unit as data groups for each measuring of time, and stores the data groups in association with protection information showing whether the data groups are in a protection state or an unprotected state; an input unit that receives an input of an instruction; a protection information setting unit that sets the protection information stored in the memory unit on the basis of the instruction received by the input unit; and a deleting unit that deletes data of the data groups that are in the unprotected state from the memory unit, on the basis of the protection information stored in the memory unit, when there is no capacity for storing the values of the times measured by the time measuring unit in the memory unit.

A program enables a computer to perform: measuring time; storing the values of the times measured by the measuring of time as data groups for each measuring of time, and storing the data groups in a memory unit in association with protection information showing whether the data groups are in a protection state or an unprotected state; receiving an input of an instruction; setting the protection information stored in the memory unit on the basis of the instruction received in the receiving of the input; and deleting data of the data groups that are in the unprotected state from the memory unit, on the basis of the protection information stored in the memory unit, when there is no capacity for storing the values of the time measured by the measuring of time in the memory unit.

According to the present application, the time measuring unit measures time. Further, the memory unit stores the values of the times measured by the time measuring unit as data groups for each measuring of time, and stores the data groups in association with protection information showing whether the data groups are in a protection state or an unprotected state. Further, the input unit receives an instruction as an input. Further, the protection information setting unit sets protection information stored in the memory unit on the basis of the instruction received by the input unit. Further, the deleting unit deletes the data of data groups in an unprotected state from the memory unit, on the basis of the protection information stored in the memory unit, when there is no capacity for storing the time values measured by the time measuring unit in the memory unit. Therefore, it is possible to store a newly measured time value, without deleting protection target data, that is, data to remain, even if there is no capacity for storing the time values measured by the time measuring unit in the memory unit.

### BRIEF DESCRIPTION OF THE DRAWINGS

FIG. 1 is a block diagram showing the configuration of an electronic timepiece according to a first embodiment of the present invention.

FIG. 2 is a schematic diagram showing the data structure of a timing file stored in a memory unit in the first embodiment of the present invention.

FIG. 3 is a schematic diagram showing the data structure of a total capacity file of unprotected data groups stored in a memory unit in the first embodiment of the present invention.

FIG. 4 is a flowchart illustrating the operation sequence of an electronic timepiece according to the first embodiment of the present invention.

FIG. 5 is a flowchart illustrating the operation sequence for deleting a data group stored in a memory unit of an electronic timepiece according to the first embodiment of the present invention, in response to an instruction of a user.

FIG. 6 is a flowchart illustrating the operation sequence of an electronic timepiece according to a second embodiment of the present invention.

### DETAILED DESCRIPTION OF THE INVENTION

### First Embodiment

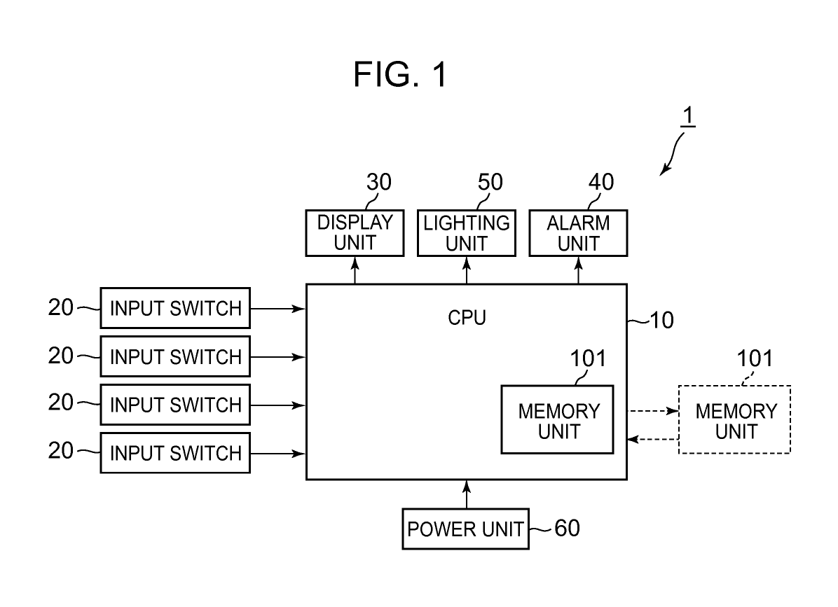

Hereinafter, a first embodiment of the present invention will be described with reference to the drawings. The embodiment describes an electronic timepiece as an example of an electronic device. FIG. 1 is a block diagram showing the configuration of an electronic timepiece 1 (electronic device) according to the embodiment. In the example shown in the figure, an electronic timepiece 1 includes a CPU 10 (time measuring unit, protection information setting unit, a deleting unit, a feature determining unit, and a condition selecting unit), an input switch 20, a display unit 30, alarm unit 40, a lighting unit 50, and a power unit 60.

The CPU 10 includes a memory unit 101 (memory unit and capacity memory unit). The memory unit 101 includes a RAM (Random Access Memory) storing measured time (the value of a measured time) and a ROM (Read Only Memory) storing programs. For example, all or some of the memory unit 101 may be nonvolatile memories. The CPU 10 controls the parts of the electronic timepiece 1 or measures time by reading out the programs stored in the memory unit 101 and executing the programs. In detail, the CPU 10 operates as a time measuring unit that measures time. Further, the CPU 10 operates as a protection information setting unit that sets protection flags (protection information) stored in the memory unit 101. Further, the CPU 10 operates as a deleting unit that deletes data stored in the memory unit 101. Further, the detailed operation of the CPU 10 is described below.

The input switch 20 receives an instruction as an input from a user. In the example described in the figure, the electronic timepiece 1 includes four input switches 20. The display unit 30 may be a liquid crystal panel and displays time or a time value. The alarm unit 40 output an alarm or an operation confirmation sound. The lighting unit 50 lights the display unit 30. The power unit 60 may be a battery and supplies power of the parts of the electronic timepiece 1. Further, although the CPU 10 includes the memory unit 101, the invention is not limited thereto. For example, as shown by a broken line in FIG. 1, the electronic timepiece 1 may include the memory unit 101 outside the CPU 10.

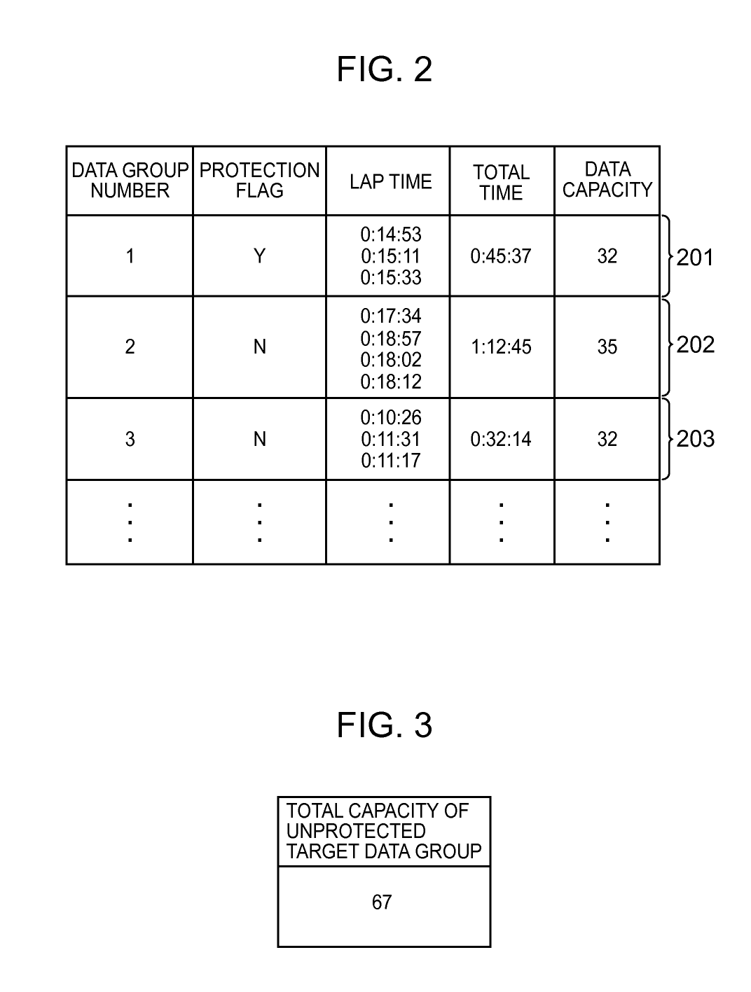

Next, a time measuring file stored in the memory unit 101 is described. FIG. 2 is a schematic diagram showing the data structure of a time measuring file stored in the memory unit 101 in the embodiment. The time measuring file has data items of ‘data group number’, ‘protection flag’, ‘lap time’, ‘total time’, and ‘data capacity’ and stores data stored in the data items in association with each other for each row. The data associated with each other for each row is called a data group.

The data item ‘data group number’ stores the number that uniquely specifies the data group. Each data group is given a data group number from 1 in accordance with the order of measuring time. That is, the data group number of the data group of the oldest measured time is ‘1’. Further, the data groups are arranged in the order of earliest measurement in the time measuring file.

The data item ‘protection flag’ stores data showing whether the data stored in the data item ‘lap time’ and the data item ‘total time’ in the same row is protection target data (in a protection state). In detail, when the data stored in the data item ‘protection flag’ is ‘Y’, it is shown that the data stored in the data item ‘lap time’ and the data item ‘total time’ in the same row is protection target data. On the other hand, when the data stored in the data item ‘protection flag’ is ‘N’, it is shown that the data included in the data item ‘lap time’ and the data item ‘total time’ in the same row is not data to be protected (unprotected target data).

The data item ‘lap time’ stores a lap time (section lap time) measured by the CPU 10. When there is a plurality of lap times, the plurality of lap times are stored. The data item ‘total time’ stores a total time (accumulated time) measured by the CPU 10. The data item ‘data capacity’ stores the data capacity stored in the data item in the same row. Further, the unit of the data capacity stored in the data item ‘data capacity’ is ‘byte’.

In the example shown in the figure, in the row 201, the value stored in the data item ‘data group number’ is ‘1’, the value stored in the data item ‘protection flag’ is ‘Y’, the values stored in the data item ‘lap time’ are ‘0:14:53’, ‘0:15:11’, and ‘0:15:33’, the value stored in the data item ‘total time’ is ‘0:45:37’, and the value stored in the data item ‘data capacity’ is ‘32’.

This shows that the data of the data group specified by the data group number ‘1’ is protection target data, the lap times are ‘0:14:53’, ‘0:15:11’, and ‘0:15:33’, the total time is ‘0:45:37’, and the data capacity is ‘32 bytes’. Further, the other rows are as those shown in the figure. Further, although the time measuring file includes the data item of ‘data capacity’ in the example shown in the figure, the invention is not limited thereto. For example, it may be possible that when the time measuring file is not provided with the data item ‘data capacity’ and the value of the data capacity is necessary, the CPU 101 calculates the data capacity every time the data capacity is necessary.

Next, an unprotected data group-total capacity file stored in the memory unit 101 is described. FIG. 3 is a schematic diagram showing the data structure of an unprotected data group-total capacity file stored in the memory unit 101 in the embodiment. The unprotected data group-total capacity file stores the total capacity of the unprotected files in the data groups stored in the memory unit 101. Further, the unit of the total capacity of the data file is ‘byte’. The example shown in the figure shows that the total capacity of the unprotected files in the data groups stored in the memory unit 101 is 67 bytes.

Next, a method of setting protection/non-protection of data groups is described. In the embodiment, for example, the input switches 20 of the electronic timepiece 1 receive instructions input from a user and the CPU 10 sequentially displays the data (lap time and total time) of the data groups stored in the memory unit 101 on the display unit 30 on the basis of the instructions. When protection or unprotected data of the data groups is displayed on the display unit 30, the user inputs instructions of making the data groups of the displayed data protection targets or unprotected targets by operating the input switches 20. The CPU 10 of the electronic timepiece 1 changes the value of the data item ‘protection flag’ of the time measuring file stored in the memory unit 101 on the basis of the instructions received by the input switches 20. In detail, when the switch 20 receives an instruction for protection, the CPU 10 of the electronic timepiece 1 changes the protection flag of the data group of the data displayed on the display unit 30 into ‘Y’. On the other hand, when the switch 20 receives an instruction for unprotected, the CPU 10 of the electronic timepiece 1 changes the protection flag of the data group of the data displayed on the display unit 30 into ‘N’. Accordingly, the electronic timepiece 1 can set the protection/non-protection of data groups.

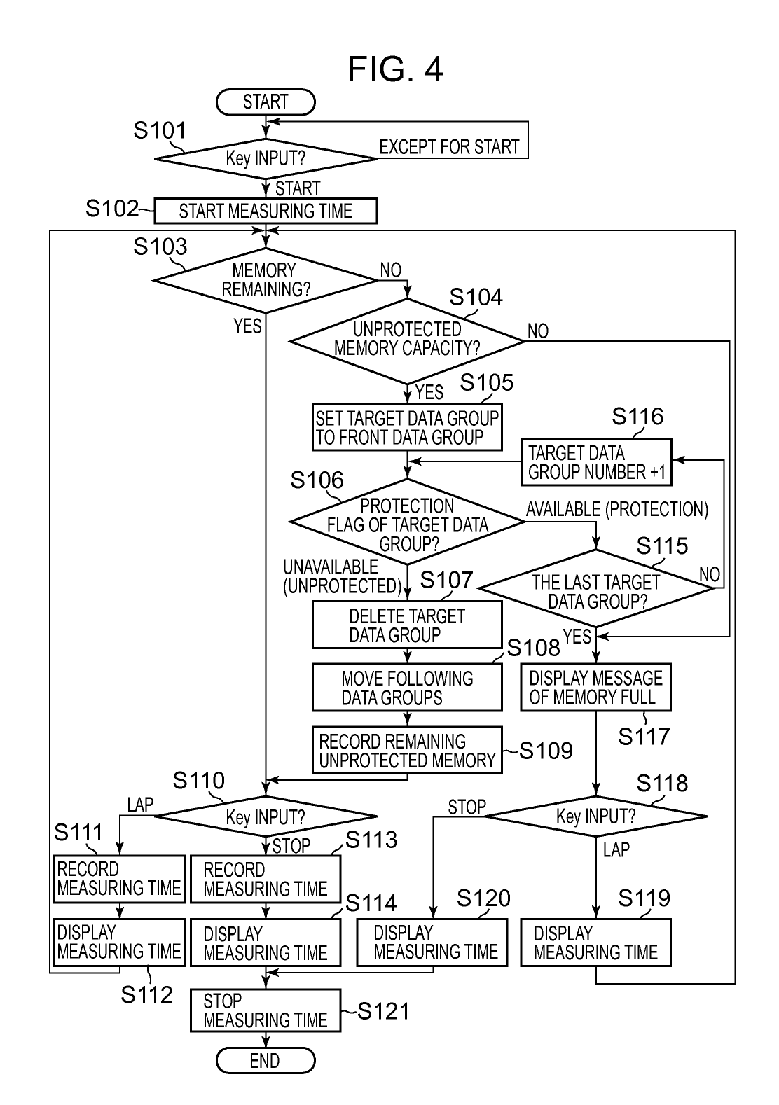

Next, the operation of measuring time of the electronic timepiece 1 is described. FIG. 4 is a flowchart showing the order of measuring time of the electronic timepiece 1. The flowchart shown in the figure shows the process order when the electronic timepiece 1 performs one-time process of measuring time.

A user inputs an instruction of ‘START’ by operating the input switch 20 to start measuring time (step S101). The CPU 10 determines whether the input switch 20 has received the input ‘START’ giving an instruction of start measuring time. When the CPU 10 determines that the input ‘START’ has been received, the process proceeds to step S102, but in the other case, step S101 is performed again.

The CPU 10 starts measuring time (step S102). Further, the CPU 10 determines a data group number that specifies the value of the measured time (the measured time value). For example, the CPU 10 determines the smallest natural number in the data group numbers not stored in the memory unit 101 as the data group number of the value of the measured time (the measured time value). Thereafter, the process proceeds to step S103.

The CPU 10 determines whether there is a remaining memory capacity (capacity for storing data groups) in the memory unit 101 (step S103). When the CPU 10 determines that there is a remaining memory capacity in the memory unit 101, the process proceeds to step S110, or when the CPU 10 determines that there is no remaining memory capacity of the memory unit 101, the process proceeds to step S104. For example, it may be possible that the memory unit 101 stores the present remaining memory capacity and the CPU 10 determines whether there is a remaining memory capacity of the memory unit 101 on the basis of the present remaining memory capacity stored in the memory unit 101.

The CPU 10 determines whether the unprotected memory capacity (the sum of the data capacity of the unprotected groups in the data groups stored in the memory unit 101) is a predetermined capacity or more in the memory unit 101 (step S104). When the CPU 10 determines that the unprotected memory capacity is a predetermined capacity or more in the memory unit 101, the process proceeds to step S105, or proceeds to step S117 in the other case. The predetermined capacity is, for example, a capacity that can store one lap time. Further, for example, when the capacity value of the unprotected memory capacity is stored in the total capacity file of unprotected data groups of the memory unit 101 and the capacity value of the unprotected memory capacity is less than the predetermined capacity, the CPU 10 may determine that there is no unprotected memory capacity, or when the capacity value of the unprotected memory capacity is the predetermined capacity or more, the CPU 10 may determine that there is an unprotected memory capacity. Further, for example, the memory unit 101 may store the data capacity of the protection data groups and the data capacity of the unprotected data groups.

The CPU 10 selects the data group with the smallest group number (the front data group) as a target data group from the data groups stored in the memory unit 101 (step S105). Thereafter, the process proceeds to step S106.

The CPU 10 determines whether the protection flag of the target data group is ‘Y (available, protection)’ or ‘N (unavailable, unprotected)’ (step S106). When the CPU 10 determines whether the protection flag of the target data group is ‘Y’, the process proceeds to step S115, or when the CPU 10 determines that the protection flag is ‘N’, the process proceeds to step S107.

The CPU 10 deletes the target data group from the memory unit 101 (step S107). Thereafter, the process proceeds to step S108.

The CPU 10 decrements the data group numbers larger than the data group number of the deleted target data group by one by performing the process of step S107 (step S108). That is, the data group numbers after the data group number of the target data group deleted by step S107 are moved. Thereafter, the process proceeds to step S109.

The CPU 10 calculates an unprotected memory capacity and stores it to the total capacity file of unprotected data groups of the memory unit (step S109). Thereafter, the process proceeds to step S110.

The CPU 10 determines whether the input switch 20 has received an input ‘LAP’ giving an instruction of acquiring a lap time or an input ‘STOP’ giving an instruction of stopping measuring time (step S110). When the CPU 10 determines that the input ‘LAP’ has been received, the process proceeds to step S111, and when the CPU 10 determines that the input ‘STOP’ has been received, the process proceeds to step S113.

The CPU 10 determines the time until the input ‘LAP’ is received as a lap time in the process of step S110 from the measuring of time in step S102 (step S111). Further, when the input ‘LAP’ has been received twice or more, the time until the input ‘LAP’ is finally received after the second input ‘LAP’ from the last is determined as a lap time. Continuously, the CPU 10 stores the determined lap time to the memory unit 101 in association with the data group number determined in step S102. Thereafter, the process proceeds to step S112.

The CPU 10 displays the lap time determined in step S111 on the display unit 30 (step S112). Thereafter, the process returns to step S103.

The CPU 10 determines the time until the input ‘STOP’ is received as a lap time in the process of step S110 from the measuring of time in step S102 (step S113). Further, when the input ‘LAP’ has been received once or more, the time until the input ‘LAP’ is received after the input ‘STOP’ at the last is determined as a lap time. The CPU 10 determines the time until the input ‘STOP’ is received as a total time in the process of step S110 from the measuring of time in step S102. Continuously, the CPU 10 stores the determined lap time and the total time to the memory unit 101 in association with the data group number determined in step S102. Thereafter, the process proceeds to step S114.

The CPU 10 displays the lap time and the total time determined in step S113 on the display unit 30 (step S114). Thereafter, the process proceeds to step S121.

The CPU 10 determines whether the data group number of the target data group is the last number (the largest number in the data group numbers stored in the memory unit 101) (step S115). When the CPU 10 determines that the data group number of the target data group is the last number, the process proceeds to step S117, and in the other cases, the process proceeds to step S116.

The CPU 10 selects the data group with a data group number larger by one than the data group number of the present target data group, as a target data group (step S116). Thereafter, the process returns to step S106.

The CPU 10 displays a message ‘memory FULL’, which says that there is not available space in the memory capacity of the memory unit 101 (the memory unit 101 cannot stores a measured time value) to the user, on the display unit 30 (step S117). Thereafter, the process proceeds to step S118. The users can recognize that there is no available memory capacity in the electronic timepiece 1 by checking the message ‘memory FULL’ displayed on the display unit 30.

The CPU 10 determines whether the input switch 20 has received an input ‘LAP’ or an input ‘STOP’ (step S118). When the CPU 10 determines that the input ‘LAP’ has been received, the process proceeds to step S119, and when the CPU 10 determines that the input ‘STOP’ has been received, the process proceeds to step S120.

The CPU 10 determines the time until the input ‘LAP’ is received as a lap time in the process of step S118 from the measuring of time in step S102 (step S119). Further, when the input ‘LAP’ has been received twice or more, the time until the input ‘LAP’ is finally input after the second input ‘LAP’ from the last is determined as a lap time. Continuously, the CPU 10 displays the determined lap time on the display unit 30. Thereafter, the process returns to step S103.

The CPU 10 determines the time until the input ‘STOP’ is received as a lap time in the process of step S118 from the measuring of time in step S102 (step S120). Further, when the input ‘LAP’ has been received once or more, the time until the input ‘LAP’ is received after the input ‘STOP’ at the last is determined as a lap time. The CPU 10 determines the time until the input of ‘STOP’ is received as a total time in the process of step S118 from the measuring of time in step S102. Continuously, the CPU 10 displays the determined lap time and total time on the display unit 30. Thereafter, the process proceeds to step S121.

The CPU 10 stops the process of measuring time (step S121). Thereafter, the process is finished.

The electronic timepiece 1 does not delete the protection target data groups from the memory unit 101, but deletes the unprotected target data groups from the memory unit 101, when there is no available capacity where a lap time or a total time can be stored in the memory unit 101, by performing steps S101 to S121. Therefore, the electronic timepiece 1 can store a lap time or a total time, which is newly measured, without deleting data that the user wants to remain, even if there is no available capacity in the memory unit 101.

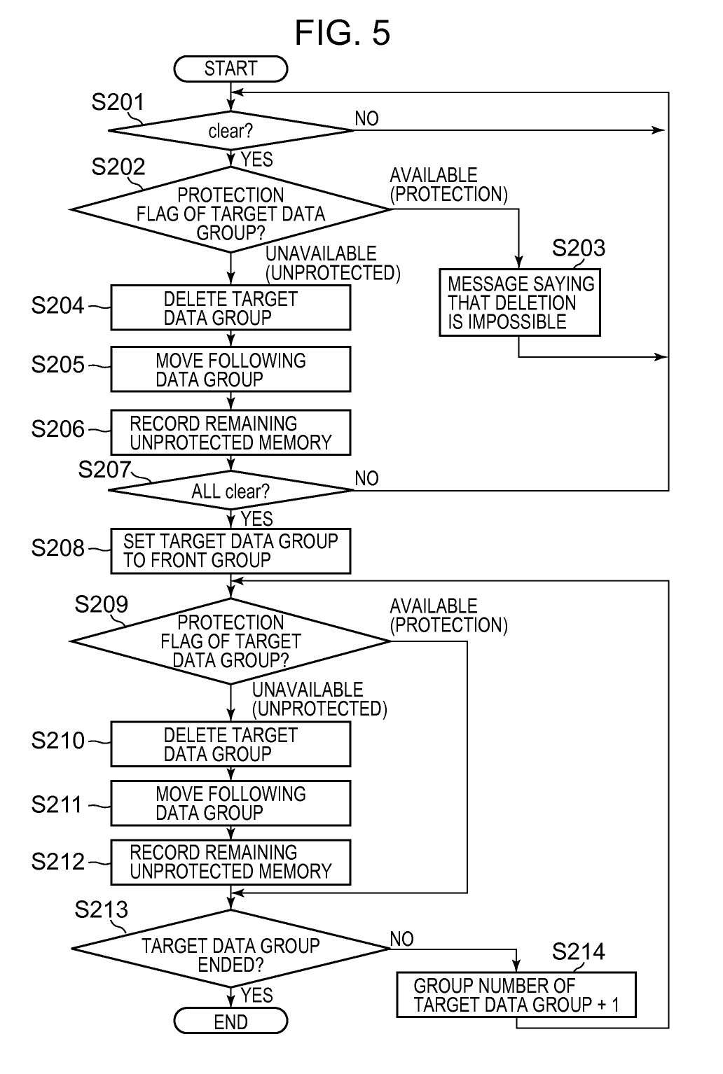

Next, the operation sequence of deleting the data groups stored in the memory unit 101 of the electronic timepiece 1 in accordance with an instruction of a user. FIG. 5 is a flowchart illustrating the operation sequence for removing a data group stored in the memory unit 101 of the electronic timepiece 1 according to the embodiment of the present invention, in response to an instruction of a user.

A user selects a data group (target data group) to delete by operating the input switch 20 and then inputs ‘clear’ giving an instruction of deleting the target data group, in order to delete a data group stored in the memory unit 101 of the electronic timepiece 1 (step S201). The CPU 10 determines whether the input switch 20 has received the input of indicating the target data group and the input ‘clear’. When the CPU 10 determines that received the input of indicating the target data group and the input ‘clear’ have been received, step S202 is performed, but in the other case, step S201 is performed again.

The CPU 10 determines whether the protection flag of the target data group is ‘Y (available, protection)’ or ‘N (unavailable, unprotected)’ with reference to the time measuring file stored in the memory unit 101 (step S202). When the CPU 10 determines that the protection flag of the target data group is ‘Y’, the process proceeds to step S203, or when the CPU 10 determines that the protection flag is ‘N’, the process proceeds to step S204.

Since the protection flag of the target memory is ‘Y’, the CPU 10 displays a message ‘deleting impossible’ that is a message saying that the target data group cannot be deleted to the user, on the display unit 30 (step S203). Thereafter, the process returns to step S201.

The CPU 10 deletes the target data group from the memory unit 101 (step S204). Thereafter, the process proceeds to step S205.

The CPU 10 decrements the data group numbers larger than the data group number of the deleted target data group by one by performing the process of step S204 (step S205). That is, the data group numbers after the data group number of the target data group deleted by step S204 are moved. Thereafter, the process proceeds to step S206.

The CPU 10 calculates an unprotected memory capacity and stores it to the memory unit 101 (step S206). Thereafter, the process proceeds to step S207.

The user inputs ‘ALLclear’ giving an instruction of deleting all the data groups of the unprotected target by operating the input switch 20 in order to delete all the data groups of the unprotected target in the data groups stored in the memory unit 101 of the electronic timepiece 1 (step S207). The CPU 10 determines whether the input switch 20 has received the input ‘ALLclear’. When the CPU 10 determines that the input ‘ALLclear’ has been received, step S208 is performed, but in the other case, the process returns the step S201.

The CPU 10 selects the data group with the smallest group number (the front data group) as a target data group from the data groups stored in the memory unit 101 (step S208). Thereafter, the process proceeds to step S209.

The CPU 10 determines whether the protection flag of the target data group is ‘Y’ or ‘N’ with reference to the time measuring file stored in the memory unit 101 (step S209). When the CPU 10 determines that the protection flag of the target data group is ‘Y’, the process proceeds to step S213, or when the CPU 10 determines that the protection flag is ‘N’, the process proceeds to step S210.

The CPU 10 deletes the target data group from the memory unit 101 (step S210). Thereafter, the process proceeds to step S211.

The CPU 10 decrements the data group numbers larger than the data group number of the deleted target data group by one by performing the process of step S210 (step S211). That is, the data group numbers after the data group number of the target data group deleted by step S210 are moved. Thereafter, the process proceeds to step S212.

The CPU 10 calculates an unprotected memory capacity and stores it to the total capacity file of unprotected data groups of the memory unit 101 (step S212). Thereafter, the process proceeds to step S213.

The CPU 10 determines whether the data group number of the target data group is the last number (the largest number in the data group numbers stored in the memory unit 101) (step S213). When the CPU 10 determines that the data group number of the target data group is the last number, the process is finished, and in the other cases, the process proceeds to step S214.

The CPU 10 selects the data group with a data group number larger by one than the data group number of the present target data group, as a target data group (step S214). Thereafter, the process returns to step S209.

The electronic timepiece 1 can delete data groups from the memory unit 101 on the basis of an instruction of a user by performing the processes of steps S201 to S214. Further, since the electronic timepiece 1 does not delete the protection target data groups even if it receives an instruction of deleting the protection target data groups from the user, it is possible to prevent the protection target data groups from being deleted by mistake.

As described above, the electronic timepiece 1 can set protection/non-protection of data groups on the basis of an instruction of a user. Further, the electronic timepiece 1 does not delete the protection target data groups from the memory unit 101, but deletes the unprotected target data groups from the memory unit 101, when there is no available capacity where a lap time or a total time can be stored in the memory unit 101. Therefore, the electronic timepiece 1 can store a lap time or a total time, which is newly measured, without deleting data that the user wants to remain, even if there is no available capacity in the memory unit 101.

### Second Embodiment

Next, the second embodiment of the invention is described. The present embodiment is different from the first embodiment in that the values of data groups having features are protected not to be automatically deleted in the present embodiment. Further, in the present embodiment, an electronic timepiece 1 has the same configuration as the electronic timepiece 1 of the first embodiment. Further, a CPU 10 of the present embodiment operates as a feature determining unit that determines whether a measure time value is a feature value, in addition to the operations described in the first embodiment. Further, the CPU 10 also operates as a condition selection unit that selects a condition for determining whether a measure time value is a feature value.

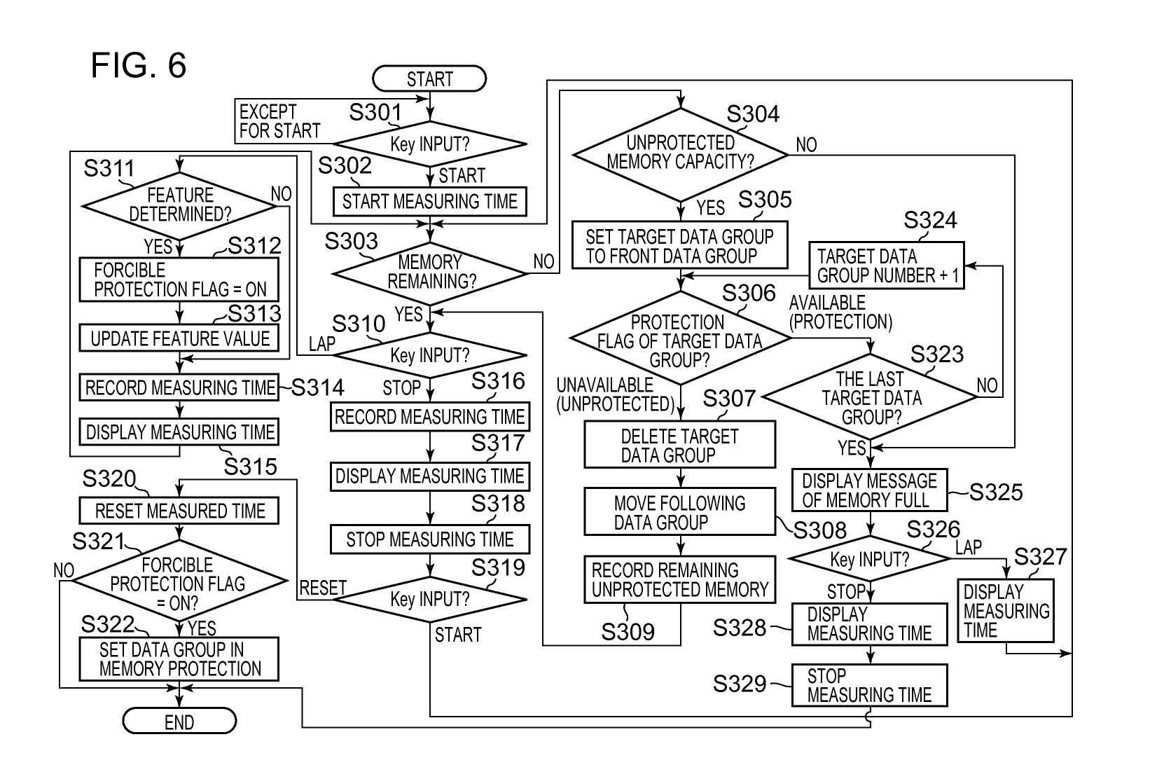

Next, the operation of measuring time of the electronic timepiece 1 is described. FIG. 6 is a flowchart showing the order of measuring time of the electronic timepiece 1. The flowchart shown in the figure shows the process order when the electronic timepiece 1 performs one-time process of measuring time.

The processes of steps S301 to S309 are the same as those of steps S101 to S109 of the first embodiment.

The CPU 10 determines whether the input switch 20 has received an input ‘LAP’ or an input ‘STOP’ (step S310). When the CPU 10 determines that the input of ‘LAP’ has been received, the process proceeds to step S311, and when the CPU 10 determines that the input of ‘STOP’ has been received, the process proceeds to step S316.

The CPU 10 determines the time until the input ‘LAP’ is received as a lap time in the process of step S310 from the measuring of time in step S302 (step S311). Further, when the input ‘LAP’ has been received twice or more, the time until the input ‘LAP’ is finally input after the second input ‘LAP’ from the last is determined as a lap time. Continuously, the CPU 10 determines whether the determined lap time has a feature. When the CPU 10 determines that the determined lap time has a feature, the process proceeds to step S312, and in other cases, the process proceeds to step S314.

For example, when the determined lap time is earlier than all the other lap times stored in the memory unit 101, that is, is the shortest time, the CPU 10 determines that the determined lap time has a feature. Further, the CPU 10 may determine whether a newly determined lap time has a feature by storing the lap time that is determined to have a feature in the memory unit 101 and comparing the feature value stored in the memory unit 101 with the newly determined lap time. Further, it may be possible to determine that not only the shortest time, but a plurality of lap times, for example, earlier three times, has features. Further, not for the shortest time, but for the longest time, it may be possible to determine that the determined lap time has a feature. Further, when the electronic timepiece 1 is equipped with a pedometer, the CPU 10 may determine that the lap time for the highest speed or the lap time for the longest distance has a feature by using a distance based on the number of steps or the strides.

Further, when the input switch 20 has received an input of instructing a condition for determining whether there is a feature, the CPU 10 may set a condition for determining that it is a feature value, on the basis of the condition received by the input switch 20. For example, when the input switch 20 has received an input of instructing the ‘shortest time’ as the condition for determining whether there is a feature, the CPU 10 sets the condition for determining whether it is a feature value as the ‘shortest time’. In this case, when the lap time determined by the process of step S311 is the shortest time, the CPU 10 determines that the lap time has a feature.

The CPU 10 turns on a forcible protection flag showing that the present measure time value is the value of a protection target (step S312). Thereafter, the process proceeds to step S313.

The CPU 10 stores the lap time determined by the process of step S311 in the memory unit 101 as a feature value (step S313). Further, when a feature value is stored in advance in the memory unit 101, the feature value stored in the memory unit 101 is updated to a newly determined lap time. Thereafter, the process proceeds to step S314.

The CPU 10 stores the lap time determined by the process of step S311 in the memory unit 101 in association with the data group number determined by the process of step S302 (S314). Thereafter, the process proceeds to step S315.

The CPU 10 displays the lap time determined in step S311 on the display unit 30 (step S315). Thereafter, the process returns to step S303.

The CPU 10 determines the time until the input ‘STOP’ is received as a lap time in the process of step S310 from the measuring of time in step S302 (step S316). Further, when the input ‘LAP’ has been received once or more, the time until the input ‘LAP’ is received after the input ‘STOP’ at the last is determined as a lap time. The CPU 10 determines the time until the input ‘STOP’ is received as a total time in the process of step S310 from the measuring of time in step S302. Continuously, the CPU 10 stores the determined lap time and the total time to the memory unit 101 in association with the data group number determined in step S302. Thereafter, the process proceeds to step S317.

The CPU 10 displays the lap time and the total time determined in step S316 on the display unit 30 (step S317). Thereafter, the process proceeds to step S318. The CPU 10 stops the process of measuring time (step S318). Thereafter, the process proceeds to step S319.

The CPU 10 determines whether the input switch 20 has received an input ‘START’ or an input ‘RESET’ (step S319). When the CPU 10 determines that the input of ‘START’ has been received, measuring of time is started again and the process returns to step S303, and when the CPU 10 determines that the input of ‘RESET’ has been received, the process proceeds to step S320.

The CPU 10 resets the measured time value (step S320). Thereafter, the process proceeds to step S321.

The CPU 10 determines whether the forcible protection flag has been turned on (step S321). When the CPU 10 determines that the forcible protection flag has been turned on, the process proceeds to step S322, and in the other case, the process is finished.

The CPU 10 stores the protection flag of the data group specified with the data group number determined by the process of step S302, as ‘Y’, in the memory unit 101 (S322). Thereafter, the process is finished.

The processes of steps S323 to S329 are the same as those of steps S115 to S121 of the first embodiment.

As described above, according to the embodiment, the electronic timepiece 1 can automatically make the data groups including a lap time having a feature protection targets, without an instruction of a user. Therefore, it is possible to automatically make the data groups including lap times to be generally kept, such as the earliest lap time, a protection target. Further, the electronic timepiece 1 does not delete the protection target data groups from the memory unit 101, but deletes the unprotected target data groups from the memory unit 101, when there is no available capacity where a lap time or a total time can be stored in the memory unit 101. Therefore, the electronic timepiece 1 can store a lap time or a total time, which is newly measured, without deleting data that the user wants to remain, even if there is no available capacity in the memory unit 101.

Further, all or some of the functions of the units in the electronic timepieces 1 in the first embodiment and the second embodiment may be implemented by recording programs for implementing the functions on a computer-readable recording medium and reading and executing the programs recorded on the recording medium with a computer system. The ‘computer system’ described herein includes an OS or hardware, such as peripheral devices.

Further, the ‘computer-readable recording medium’ may be a removable medium, such as a flexible disk, an optical magnetic disk, a ROM, and a CD-ROM, or the memory unit, such as a hard disk in a computer system. Further, the ‘computer-readable recording medium’ may include a medium that dynamically keeps a program for a short time, such as the communication line when a program is transmitted through a network, such as the internet, or a communication wire, such as a telephone line, and a medium that keeps a program for a predetermined time, such as a volatile memory in a computer system that is a server or a client in the above case. Further, the program may be a program for implementing some of the functions described above, or the functions may be implemented by combining them with a program recorded in advance in a computer system.

Although the first embodiment and the second embodiments of the invention were described above, the invention is not limited to the embodiments and may be modified in various ways without departing from the spirit of the invention.

For example, although the electronic timepiece 1 shown in FIG. 1 was described as an example of an electronic device in the embodiments, it is not limited thereto and any electronic devices may be used. Further, although it was prevented to delete protection target data groups from the memory unit 101, when an input switch 20 having a specific configuration is pressed down, it may be possible to further provide a function of deleting all the data groups stored in the memory unit 101, including the protection target data groups.

What is claimed is:

1. An electronic device comprising:
a time measuring unit that measures time;
a memory unit that stores the values of the times measured by the time measuring unit as data groups for each measuring of time, and stores the data groups in association with protection information showing whether the data groups are in a protection state or an unprotected state;
an input unit that receives an input of an instruction;
a protection information setting unit that sets the protection information stored in the memory unit on the basis of the instruction received by the input unit; and
a deleting unit that deletes data of the data groups that are in the unprotected state from the memory unit, on the basis of the protection information stored in the memory unit, when there is no capacity for storing the values of the times measured by the time measuring unit in the memory unit.

2. The electronic device according to claim 1, further comprising a capacity memory unit that stores the data capacity that the memory unit can store and the total data capacity of the data groups in the unprotected state which are stored in the memory unit, or stores the total data capacity of the data group in the protection state which are stored in the memory unit and the total data capacity of the data groups in the unprotected state which are stored in the memory unit.

3. The electronic device according to claim 1, wherein the deleting unit individually deletes the data groups stored in the memory unit or deletes all the data groups in the unprotected state in the data groups stored in the memory unit, on the basis of the instruction received by the input unit.

4. The electronic device according to claim 2, wherein the deleting unit individually deletes the data groups stored in the memory unit or deletes all the data groups in the unprotected state in the data groups stored in the memory unit, on the basis of the instruction received by the input unit.

5. The electronic device according to claim 1, further comprising a feature determining unit that determines whether the value of the time measured by the time measuring unit is a feature value,
wherein the protection information setting unit, when the feature determining unit determines that the value of the time measured by the time measuring unit is the feature value, make the protection information associated with the data group including the value information showing a protection state.

6. The electronic device according to claim 2, further comprising a feature determining unit that determines whether the value of the time measured by the time measuring unit is a feature value,
wherein the protection information setting unit, when the feature determining unit determines that the value of the time measured by the time measuring unit is the feature value, make the protection information associated with the data group including the value information showing a protection state.

7. The electronic device according to claim 3, further comprising a feature determining unit that determines whether the value of the time measured by the time measuring unit is a feature value,
wherein the protection information setting unit, when the feature determining unit determines that the value of the time measured by the time measuring unit is the feature value, make the protection information associated with the data group including the value information showing a protection state.

8. The electronic device according to claim 4, further comprising a feature determining unit that determines whether the value of the time measured by the time measuring unit is a feature value,
wherein the protection information setting unit, when the feature determining unit determines that the value of the time measured by the time measuring unit is the feature value, make the protection information associated with the data group including the value information showing a protection state.

9. The electronic device according to claim 1, further comprising a condition selection unit that selects a condition for the feature determining unit to determine whether the value is a feature value.

10. The electronic device according to claim 2, further comprising a condition selection unit that selects a condition for the feature determining unit to determine whether the value is a feature value.

11. The electronic device according to claim 3, further comprising a condition selection unit that selects a condition for the feature determining unit to determine whether the value is a feature value.

12. The electronic device according to claim 4, further comprising a condition selection unit that selects a condition for the feature determining unit to determine whether the value is a feature value.

13. The electronic device according to claim 5, further comprising a condition selection unit that selects a condition for the feature determining unit to determine whether the value is a feature value.

14. The electronic device according to claim 6, further comprising a condition selection unit that selects a condition for the feature determining unit to determine whether the value is a feature value.

15. The electronic device according to claim 7, further comprising a condition selection unit that selects a condition for the feature determining unit to determine whether the value is a feature value.

16. The electronic device according to claim 8, further comprising a condition selection unit that selects a condition for the feature determining unit to determine whether the value is a feature value.

17. The electronic device according to claim 1, wherein a portion of or the entire memory unit is a nonvolatile memory.

18. The electronic device according to claim 2, wherein a portion of or the entire memory unit is a nonvolatile memory.

19. An electronic timepiece comprising:
a time measuring unit that measures time;
a memory unit that stores values of the times measured by the time measuring unit as data groups for each measuring of time, and stores the data groups in association with protection information showing whether the data groups are in a protection state or an unprotected state;
an input unit that receives an input of an instruction;
a protection information setting unit that sets the protection information stored in the memory unit on the basis of the instruction received by the input unit; and
a deleting unit that deletes data of the data groups that are in the unprotected state from the memory unit, on the basis of the protection information stored in the memory unit, when there is no capacity for storing the values of the times measured by the time measuring unit in the memory unit.

20. A program enabling a computer to perform:
measuring time;
storing the values of the times measured by the measuring of time as data groups for each measuring of time, and storing the data groups in a memory unit in association with protection information showing whether the data groups are in a protection state or an unprotected state;
receiving an input of an instruction;
setting the protection information stored in the memory unit on the basis of the instruction received in the receiving of the input; and
deleting data of the data groups that are in the unprotected state from the memory unit, on the basis of the protection information stored in the memory unit, when there is no capacity for storing the values of the time measured by the measuring of time in the memory unit.
